(19) United States
(12) Patent Application Publication
(10) Pub. No.: US 2004/0186895 A1
(43) Pub. Date: Sep. 23, 2004

(54) System and method for managing electronic messages

(76) Inventor: Robert A. Ellis, San Jose, CA (US)

Correspondence Address: William J. Kolegraff, 3119 Turnberry Way, Jamul, CA, 91935, US

(21) Appl. No.: 10/394,341

(22) Filed: Mar. 21, 2003

(51) Int. Cl. G06F 15/16

(52) U.S. Cl. 709/207

(57) ABSTRACT

The electronic message system may be used to control what messages, such as e-mail messages, are accepted and to increase messaging privacy. The electronic message management system has a set of allowed sender addresses. When an electronic message is received, the sender address of the received message is compared to the addresses in the allowed set. If the sender's address is in the set of allowed addresses, the electronic message is allowed to be presented to the user. If the electronic message is not allowed, the electronic message system may check the electronic message for an authorization code or keyword, and if the code or keyword is found, present the electronic message to the user. To facilitate consolidation of message accounts, the electronic message system may be configured to retrieve messages from other message accounts.

### BACKGROUND

The field of the present invention is computerized messaging management. More specifically, the present invention relates to multi-user computer systems configured to send and receive electronic messages such as e-mails.

For years directing marketers have sent solicitations for their products and services through the postal mail system. In many instances, these unsolicited marketing letters are not wanted and have commonly been referred to as “junk mail”. Direct marketers have taken many approaches to increase the likelihood that a person will open an unsolicited marketing piece, for example, by disguising the solicitation as a personal letter, an important business letter, or a letter from a government entity. Because of abuses to the direct mail system, several governmental agencies are involved in monitoring and protecting the rights of consumers. Further, there are lists available where a consumer can subscribe themselves and be removed from the solicitation lists used by direct mail marketers. Although such protections have not been completely satisfactory, they do provide a level of control over the amount of junk mail a person receives through the postal systems.

As protections increased against junk mail, many direct marketers moved into directly contacting individuals with unsolicited phone calls. For years, the telemarketer has made unsolicited calls, telephonically contacting individuals to make their presentation to a consumer while at home or work. Many individuals find the intrusion of the telemarketer particularly disturbing. In response, governmental agencies are now enacting additional laws to restrict the times and types of calls that can be made by telemarketers, and private industry has responded by allowing individuals to place additional security divides on their phones. For example, many telephone services now offer privacy management features where telemarketer calls are automatically rejected unless the telemarketer first passes their caller ID to the user. Further, lists are being developed where people can put their phone number on the list and telemarketers are not supposed to call any listed phone number. Again, such protections have helped, but telemarketers continue to make calls to individuals in their homes and businesses.

In another example, direct marketers have begun widely using fax machines to present their solicitations. It is now a common accordance to find unsolicited sales brochures on a fax machine, for such products as toner cartridges and travel cruises. Again, governmental and private industry have responded by providing opt-out list for avoiding receiving such faxes, and recent governmental laws are placing additional restrictions on when and how telemarketers can direct unsolicited faxes to an individual or a business.

As technologies change, direct marketers have also changed their approach to consumers. For example, with the wide proliferation of e-mail systems, direct marketers are now widely using e-mail or other electronic messaging systems to reach wide audiences. e-mail is desirable to the direct marketer because it can be distributed at a very low cost to thousands or even millions of potential customers. Further, e-mail, like the phone call, is a very personal contact with the individual. In this way, the direct marketer hopes to have an effective emotional appeal to the user.

The electronic messages sent by a direct marketer are often referred to as “SPAM”. It is now a common occurrence for a user of an e-mail system to open the inbox of an e-mail system and see several, if not tens, of unsolicited e-mails. These e-mails will include offers to purchase particular products and services, presentations of hardcore pornography, and even offensive material such as hate speech. Most people find SPAM to be a distraction to their lives, and also may be highly offended by the content of some of these unsolicited messages. Individuals spend considerable time deleting and managing SPAM, for example, in responding to individual SPAM messages in an effort to remove themselves from mailing lists. Further complicating the SPAM issue, many users are now receiving e-mails on small portable devices which communicated wirelessly with their e-mail server. The user typically pays the wireless carrier based on the volume of information passed to the wireless device. With SPAM, not only is the user receiving unsolicited messages that they do not want, but the user may be paying an additional cost to receive them.

Also, from a system wide aspect, service providers need to provide costly additional bandwidth for transmitting , storing, and handling the massive amounts of SPAM on the world-wide e-mail systems, especially Internet-based e-mail systems. As an attempt to manage SPAM, many users try to block certain addresses and certain types of e-mails from reaching their e-mail system. For example, many e-mail applications allow for placing a sender address on a “reject list”. This has been mostly ineffective, however, as direct marketers may very easily change their sender address. For example, a spamer may send out several million e-mails from a first sender address, and then within a few hours send a follow message using a different sender address. Even if the user placed the first address on the reject list, the second message would still be received by the user. In another example, many e-mail systems have a method for automatically searching through an e-mail to find identified offensive words or phrases. For example, an e-mail system may search for certain sexually oriented or hate oriented words, and upon finding those words automatically reject the e-mail. However, the direct marketers have been able to by-pass such systems by avoiding these well known key words, and placing the disturbing content in attachments in a graphical form. Thus the e-mail system may automatically review the e-mail for offensive content and not find any. The e-mail is placed in the user's inbox and the user opens the e-mail. When the user opens the attachment, the highly offensive pornographic or hate message is then displayed to the user.

The described problems with e-mail SPAM are significant for adults, but are dangerous for children. With many children now having access to internet e-mail systems, it is vitally important that offensive e-mails not find their way into a child's electronic mail inbox.

In a related problem, current e-mail systems do not provide sufficient privacy for many users. In an analogy, many people subscribe to an unlisted phone number. These people enjoy, and some require, that their personal contact information remain mostly anonymous. Again, although this may be a concern for many adults, it is critical for many children. For example, it would be desirable that a child could have a group of friends the child could safely and privately communicate with, without the risk that potentially dangerous strangers could begin communicating with the children. To date, known e-mail systems have not provided adequate protections against blocking such unsolicited, unwanted and potentially dangerous communications through the e-mail system.

It is now common for an individual to have several e-mail addresses. For example, an individual may have one or more business related addresses, one or more personal addresses for home use, one or more address used while traveling, and one of more addresses on one of the many free services. Indeed, one of the reason people keep multiple e-mail address is to have at least one address that can be used for private use. In this way, if a user receives a message on that particular e-mail system, then the user can be reasonably assured that it is a high priority E-mail. Indeed, prioritizing e-mails in an individual e-mail system may be a challenge, but prioritizing and handling e-mail messages between many e-mail accounts is very difficult and time consuming. Further, the risk of missing a high priority E-mail is quit high.

### SUMMARY

There exists a need to provide an electronic messaging system that allows a user to reject unsolicited e-mails, while allowing desired e-mails. Further, there exists a need to allow for increase privacy with an e-mail system, and to consolidate management of multiple e-mail accounts.

Briefly, the present invention provides an electronic message management system. The electronic message system may be used with e-mails, for example, to control what messages are accepted and to increase messaging privacy. The electronic message management system has a set of allowed sender addresses. When an electronic message is received, the sender address of the received message is compared to the addresses in the allowed set. If the sender's address is in the set of allowed addresses, the electronic message is allowed to be presented to the user.

In a further example of the messaging system, if the electronic message is not allowed, the electronic message system may check the electronic message for an authorization code or keyword, and if the code or keyword is found, present the electronic message to the user. To facilitate consolidation of message accounts, the electronic message system may be configured to retrieve messages from other message accounts.

Advantageously, the present invention enables a user to gain substantial control over electronic messages. For example, the user is enabled to specifically define whose messages will be received. In this way, unsolicited and unwanted messages are not allowed to be presented to the user, while allowing the messages the user wants. Accordingly, the user will spend less time managing junk messages, may avoid paying for the delivery of these messages, and gain a significant level of privacy for electronic messaging. Further, if the user has multiple message accounts, the user can consolidate management of these accounts into the electronic message management system. Such consolidation saves time, effort, and increases the likelihood of finding priority messages.

### BRIEF DESCRIPTION OF THE DRAWINGS

FIG. 1 is a functional diagram of a method for managing electronic messages in accordance with the present invention;

FIG. 2 is a flowchart of a method for managing electronic messages in accordance with the present invention;

FIG. 3 is a screen illustration useful for a method for managing electronic messages in accordance with the present invention;

FIG. 4 is a screen illustration useful for a method for managing electronic messages in accordance with the present invention;

FIG. 5 is a screen illustration useful for a method for managing electronic messages in accordance with the present invention; and

FIG. 6 is a screen illustration useful for a method for managing electronic messages in accordance with the present invention

### DETAILED DESCRIPTION

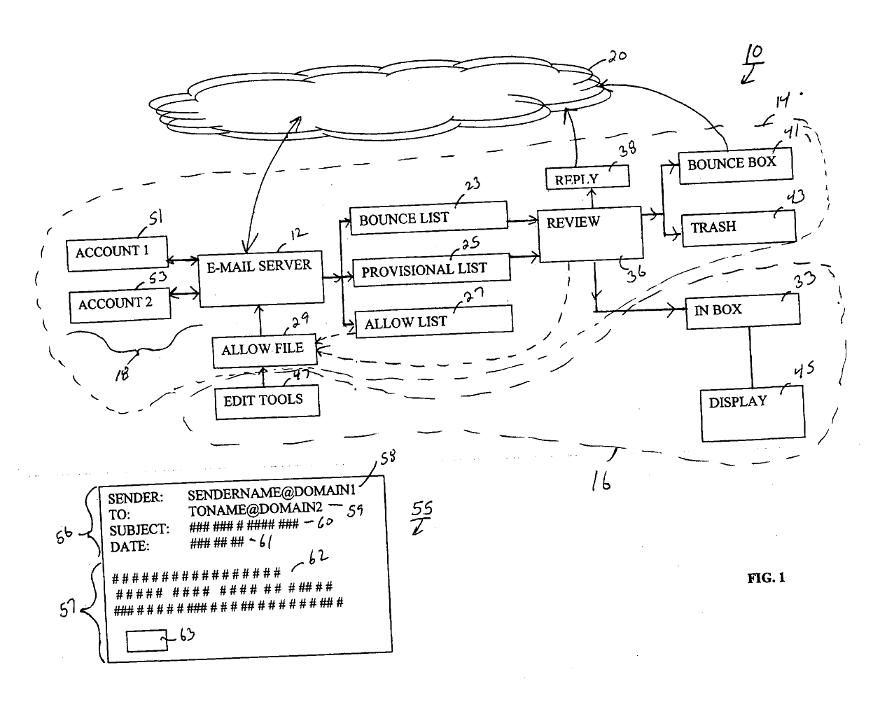

Referring now to FIG. 1 an electronic message management system is shown. The electronic message management system is shown in the form of an e-mail system 10. The e-mail system 10 has an e-mail server 12 communicating with a network, such as the Internet 20. The e-mail server 12 operates an e-mail account management process for assisting a user with the management and control of electronic messages. Although the e-mail system 10 is shown communicating with the Internet 20, it will be appreciated that the e-mail system 10 may operate on a local area network, a wide area network, or an intranet.

Preferably, the e-mail server 12 operates a POP (point of presence) manager for sending and receiving e-mails. In this way, e-mail server 12 may operate to accept e-mails from other accounts, such as account 51 and account 53. It will be appreciated that accounts 51 and 53 may be different e-mail accounts on the same server, or may be different e-mail accounts on other e-mail servers. The e-mail server 12 and the remote accounts 51 and 53 form a POP system 18 for allowing e-mail sent to the remote account to be received by the e-mail server 12. In this way, e-mail server 12 consolidates varies accounts for an individual or group of individuals. By consolidating, the user may use the email system 10 to manage e-mail messages, and is therefore relieved from setting and adjusting access controls on each of the other accounts.

An e-mail 55 is electronically communicated throughout the e-mail system 10. The e-mail 55 generally has a header section 56 and a content section 57. The header section 56 generally contains a sender address 58 and a from address 59. The addresses are typically in a standard Internet URL format and follows the form “name” followed by “@domain name”. The domain name represents a server address that uniquely identifies the mail server for all other computers connected to the Internet. The “name” portion of the URL identifies a particular e-mail account on that particular server. In this way, a full URL address uniquely identifies a single e-mail mail box on the Internet, while the domain portion represents a particular server used by many individuals. For example, many companies have a URL for their mail system that follows the form of “employee name” followed by the “@company name”. I is often possible to identify the owner of the server by reviewing the domain name portion of the URL.

The content portion 57 of the e-mail 55 often contains a textual portion 62, and an attachment 63. Due to the limited formatting available on many e-mail systems, text 62 is often limited, while larger quantities of information are included as an attachment 63. These attachments could be for example, word processing files, picture files, movie files, or other such information.

When an e-mail, such an e-mail 55 is received into the e-mail server 12, the e-mail server uses an account manager process for identifying and routing the e-mail. More particularly, the e-mail server has an allow file 29 which contains a list of allowed e-mail addresses. This list of allowed e-mail addresses may be edited using the editing tools 47. Once the e-mail server receives the e-mail 55, the e-mail server's account manager process compares the sender address to the addresses in the allow file 29 and decides if the e-mail should be placed in a bounce list 23, a provisional list 25, or an allow list 27.

If the sender address is in the allow file 29, then the e-mail server 12 routes the e-mail to the allow list 27. The allow list 27 may interact with a users inbox 33 to present the allowed e-mails to the user. The user then may display and read 45 the content section 47 of the e-mail. As the user reviews and reads the allowed e-mails, the user may perform the usual e-mail functions such as, replying to the e-mail, deleting the e-mail, or forwarding the e-mail to others. If the user receives an e-mail from a particular sender and does not desire to receive additional e-mails from this sender, the user may access the edit tools 47 to remove the particular sender's address from the allow file 29. In another example, the allow list 27 may contain an indicator such as a check box that would allow the user to indicate that this sender should be removed from the allow list.

Using the allow file as described above requires the user predefine all sender address that will be approved. Although this provides a high degree of protection from junk mail and a high level of privacy, it may not provide sufficient flexibility for some users. For example, if a user has a business e-mail address on a business card and hands the business card to several people at a business meeting, the people receiving the business card would not be able to e-mail the user unless the user entered each of their respective addresses into the allow file. As this may by unduly cumbersome for certain users, the e-mail system 10 provides a method for provisionally allowing certain e-mails. In one example, the user would provide an authorization code to people that might want to send an e-mail. For example, a user handing out a business card may include a password on the business card. Now, if the e-mail server receives an e-mail and the sender's address is not in the allow file 29, then the account management process can determine if the e-mail has a proper authorization code. The authorization code could be for example, a password placed in the subject line or in the text section of the e-mail. In another example, the authorization code could be attached as an attachment.

If the account management process determines that a proper authorization code is present in the e-mail, then the e-mail could be placed in a provisional list 25. The provisional list may then be reviewed 36 by the user, and the user would be able to determine if the e-mail should be moved into the inbox 33 for further reading and display 45, or if it should be sent to the trash 43 where it will be deleted. The unwanted e-mail may also be sent to a bounce out box 41 where the sender will be notified that the user is not accepting their e-mail, and then the e-mail deleted. As part of the review process 36, the user may add the sender's address to the allow file 29. Also, as part of the review process 36 the user may send a personal reply 38 to the sender before sending the e-mail to the inbox or trash.

When an e-mail is received where the sender's address is not in the allow file 29 and the e-mail does not contain an authorization code, the e-mail may be placed in a bounce list 23. Since the bounce list may contain unwanted e-mails such as pornographic or hate e-mails, it is preferable that the bounce list be password protected and only be viewed by an account manager. When the account manager reviews 36 the bounce list 23, the account manager may determine if a particular e-mail should be placed in inbox 33, deleted 43 without sending a replay, or routed to the bounce outbox 41. If the e-mail is sent to the bounce box 41, the sender will be notified that the e-mail is not being accepted. The account manager also has the option to reply 38 directly to the sender. If the account manager accepts one of the e-mails from the bounce list, the account manager will be able to optionally add the sender's sender address to the allow file 29.

It will be appreciated that the e-mail server system and the account manager function described above operates on a client—server system. Accordingly, a portion of the functionality will be provided on the server side, while another portion of the functionality may be provided on the client side. Server functions, such as server functions 14 are the functions most efficiently done at a central site and often act to reduce network traffic. Client functions, such as client functions 16, are preformed at the local client and are often used to preserve network band with and reduce processing power required by the client. In this way, the mail system may operate on clients having lower processing capabilities, such as a personal data assistant. It will be appreciated that some of the functions described as server functions 14 may be accomplished as client functions and that some of the functions described as client functions 16 may be implemented as server functions.

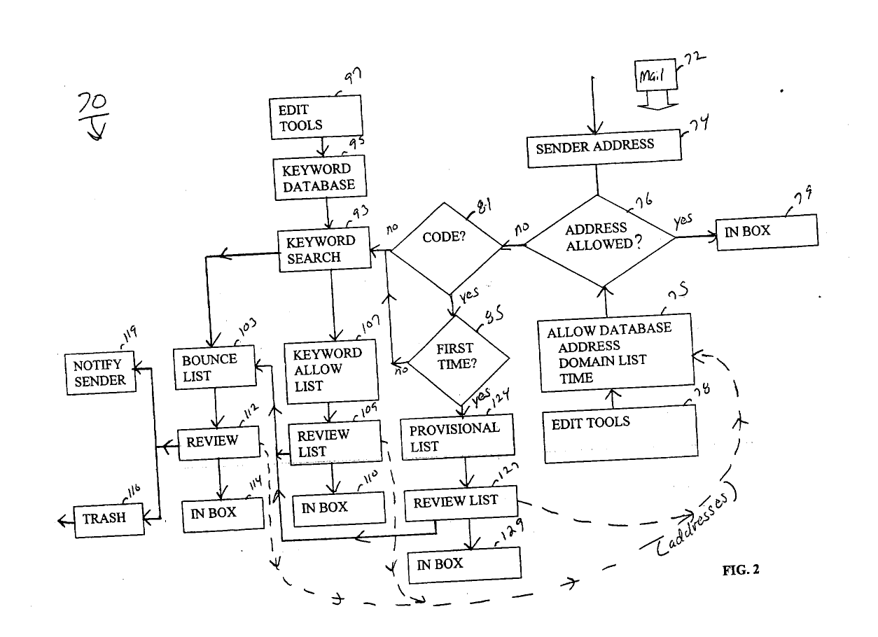

Referring now to FIG. 2 another account management system is shown in the form of an e-mail system 70. The e-mail system 70 accepts e-mails similar to e-mail 55. The e-mail 72 is received into the e-mail system 70 where the sender address is captured in block 74. The sender address is compared against addresses in the allow database 75. The allow database 75 includes specific sender addresses that are allowed. The allow database 75 also may contain a list of allowed domains. For example, the allow database may indicate that any sender from particular domain is allowed. In this way a user may set the allow list to allow any sender from within a particular company or from a particular group to send them an e-mail without having to particularly identify each and every specific full e-mail address.

The allow database 75 may also have time periods attached to one or more sender addresses. In this way a particular sender's address, or a particular domain name, may have a time limited allow period. This would be useful for example, if a user had a need to communicate with a particular sender or senders for a set duration. The time codes would then represent an additional check by the account manager to determine that the sender address was in the allow database and the time code had not yet expired. The database 75 may be edited with edit tools 78. It will be appreciated that the edit tools 78 may be used to perform standard database functions such as add, delete, edit, and categorize. The database 75 may also have a set of disabled sender addresses that may be reviewed using the edit tools 78.

In block 76, the sender's address is compared against the address in the allow database. If the sender address is found in the allow database and the time period, if any, has not expired, then the e-mail may be placed in the user's inbox 79 for normal viewing and review. If, however, the e-mail address is not in the allow database or the time code has expired, then the e-mail is checked to see if it contains a passcode in block 81. The passcode may be for example, a particular word placed in a subject line or a particular word or phrase in the text or in an attachment. If the passcode is present, then the e-mail may be passed on for review by the user. However, this may not provide sufficient security for some individuals, as once the pass code becomes widely distributed, then the usefulness of the passcode as a security device diminishes. Accordingly, a preferred embodiment of the e-mail system 10 has an additional test in block 85 that checks if this is the first time this sender address has used a passcode. If this is the first time that this particular sender has used the passcode, then the e-mail is placed in the provisional list 124 where at a later time the user may review the list 127. Upon review of the provisional list, the user may to and place the provisional e-mail in their inbox 129 or reject the sender's e-mail. The user would also be given the opportunity to add the sender's address into the allowed database 75. Although block 85 is set to check for only 1 previous use, the block may be set to check for a different number of uses. In a further refinement, multiple passwords may be used, with different access provided to each password. For example, a particular password could be used for priority business, and a different password used for personal activities. The e-mail system may be used to create different provisional lists dependant on which password is found.

If the e-mail fails the passcode check 85 and the quantity test 85, then the e-mail is forwarded to an optional keyword search 91. The optional keyword search is used to search the text, or the attachments, of an e-mail to identify those e-mails that may have content of interest to the user. The user may use edit tools 97 to generate a keyword list or database 95. The e-mails are then searched in block 93 to find one or more key words. It will be appreciated that the searching and analysis of textual content for keywords is well known. If keywords are found in an e-mail, then the e-mail is moved to a keyword allow list 107, and the user may review 109 this list at a later time. Upon review, the user may move an e-mail to the inbox 110 or delete the e-mail. The user may indicate that the sender's address should be added to the allowed database 75.

If the e-mail fails the keyword allowed search in 93, then the e-mail is placed in a bounce list 103. Since the bounce list may contain many highly undesirable e-mails such as pornographic or hate e-mails, the bounce list is preferably password protected for review 112. The user may review the bounce list and select if any listed e-mail should not be bounced, and instead should be routed to the inbox 114. The user also could indicate if a sender's address should be added to the allowed database 75. Those that fail the review 112 are then deleted from the system as shown by the trash box 116.

Optionally, the e-mails may be moved to a reply box 119 where the sender will be notified that the e-mail has been rejected. It will be appreciated that this notification may be a simple bounce back of the sent e-mail, or may contain a specific response indicating that the user is protected by an e-mail protection system.

It will be appreciated that several options exist in creating lists and setting allow options. One aspect of the e-mail system 70 is that it allows a desirable level of flexibility for the user. However, it will be appreciated that other e-mail systems are within the scope of this disclosure. For example, a highly secure e-mail system may require that every allowed email be found in the allowed database. Such a system would systematically block all other messages without notification to the user. This level of privacy and security could be highly desirable for certain individuals such as children. In another example, the provisional list or bounce list is sent to another, such as an account administrator, for review. An adult, for example, could use this to see who is attempting to send messages to a child.

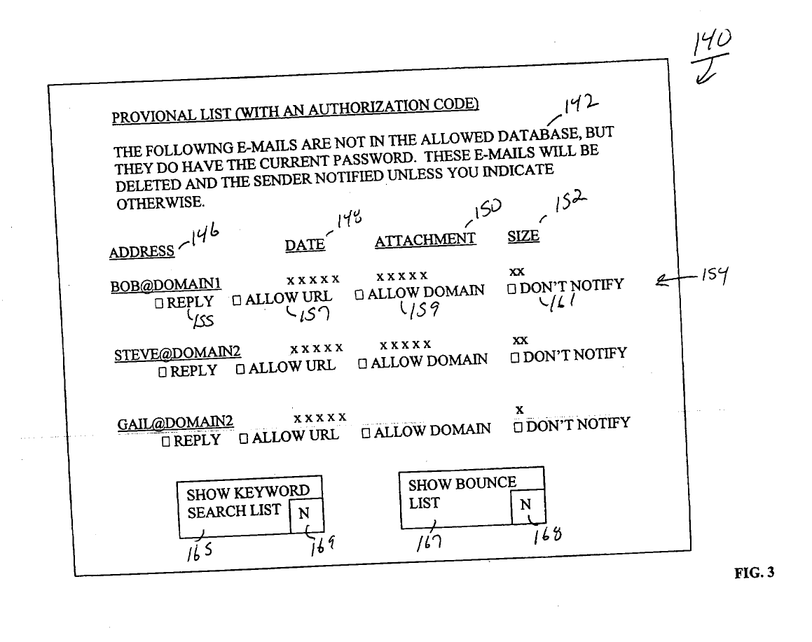

Referring now to FIG. 3, a screen illustration 140 shows an example of how a provisional list may be reviewed. The provisional list review screen many have an instruction indicating that the listed addresses were not in the allow database, but that they did have the current passcode. The text 142 may further indicate that these e-mails will be deleted and trashed after the sender is notified, unless another option is indicated. The screen illustration 140 may have a list of addresses 146 that preferably identifies further information regarding each of the e-mails. Such information could include the date sent 148, attachments 150, and size 152. For each sender address 146 the user may then indicate one or more of the specific actions 154. The actions may include “reply only” 155 which would allow the user to send a personal response back to the sender, but the sender's address would not be automatically added to the allow data base. If the user wants to add this specific e-mail address to the allow database, then the user would indicate to “accept address” 157. If the user wants to accept all users from the domain name then the user would indicate by accepting the entire domain 159. Finally, if the user did not want to send any response to the sender, then the user could indicate so in the notify box 161.

It will be appreciated that other actions could be indicated in the action area 154. It will also appreciated that the form of the provisional listing may be changed without affecting the spirit of this invention. The screen illustration 140 also shows a function button 165 for moving to the keyword allowed list and a function button 167 for moving to the bounce list. Both the function keys have a count indicator 168 and 169 so that a user could easily see how many e-mails are in each of the other lists.

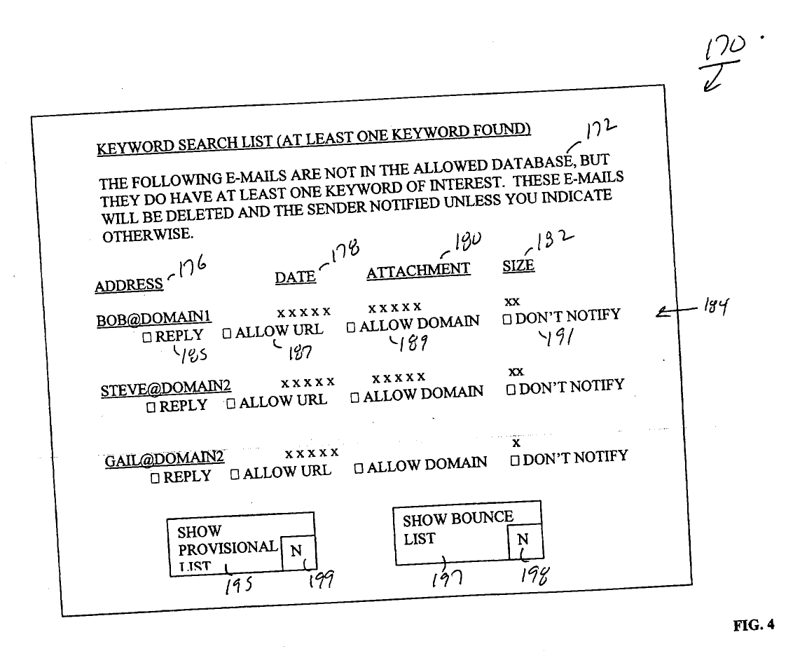

Referring now to FIG. 4, a screen illustration 170 shows an example of how a keyword allowed list may be reviewed. The keyword allowed list review screen many have an instruction indicating that the listed addresses were not in the allow database, but that they did have the one or more keywords. The text 172 may further indicate that these e-mails will be deleted and trashed after the sender is notified, unless another option is indicated. The screen illustration 170 may have a list of addresses 176 that preferably identifies further information regarding each of the e-mails. Such information could include the date sent 178, attachments 180, and size 182. For each sender address 176 the user may then indicate one or more of the specific actions 184. The actions may include “reply only” 185 which would allow the user to send a personal response back to the sender, but the sender's address would not be automatically added to the allow data base. If the user wants to add this specific e-mail address to the allow database, then the user would indicate to “accept address” 187. If the user wants to accept all users from the domain name then the user would indicate by accepting the entire domain 189. Finally, if the user did not want to send any response to the sender, then the user could indicate so in the notify box 191.

It will be appreciated that other actions could be indicated in the action area 184. It will also appreciated that the form of the keyword allow listing may be changed without affecting the spirit of this invention. The screen illustration 170 also shows a function button 195 for moving to the provisional list and a function button 197 for moving to the bounce list. Both the function keys have a count indicator 198 and 199 so that a user could easily see how many e-mails are in each of the other lists.

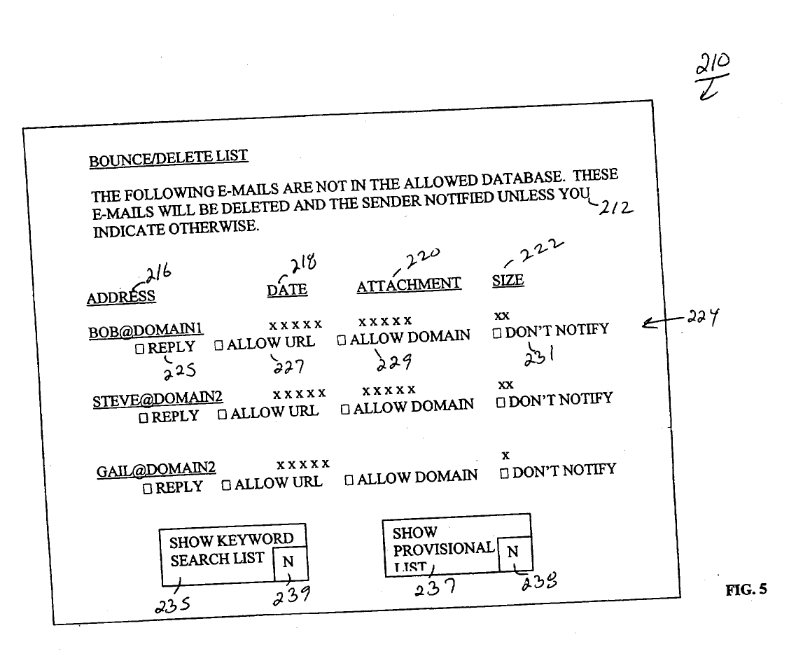

Referring now to FIG. 5, a screen illustration 210 shows an example of how a bounce list may be reviewed. The bounce list review screen many have an instruction indicating that the listed addresses were not in the allow database. The text 212 may further indicate that these e-mails will be deleted and trashed after the sender is notified, unless another option is indicated. The screen illustration 210 may have a list of addresses 216 that preferably identifies further information regarding each of the e-mails. Such information could include the date sent 218, attachments 220, and size 222. For each sender address 216 the user may then indicate one or more of the specific actions 224. The actions may include “reply only” 225 which would allow the user to send a personal response back to the sender, but the sender's address would not be automatically added to the allow data base. If the user wants to add this specific e-mail address to the allow database, then the user would indicate to “accept address” 227. If the user wants to accept all users from the domain name then the user would indicate by accepting the entire domain 229. Finally, if the user did not want to send any response to the sender, then the user could indicate so in the notify box 231.

It will be appreciated that other actions could be indicated in the action area 224. It will also appreciated that the form of the bounce listing may be changed without affecting the spirit of this invention. The screen illustration 210 also shows a function button 237 for moving to the provisional list and a function button 235 for moving to the keyword allow list. Both the function keys have a count indicator 239 and 238 so that a user could easily see how many e-mails are in each of the other lists.

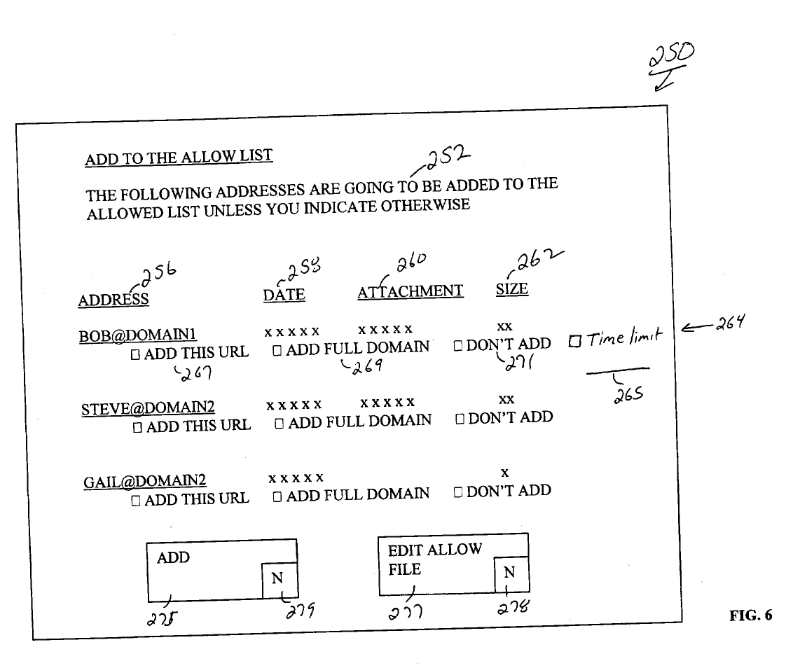

Referring now to FIG. 6, a screen illustration 250 shows an example of how sender addresses may be added to the allow database. The add screen many have an instruction indicating that the listed addresses are going to be added to the database unless another action is indicated The add screen 250 may have a list of addresses 256 that preferably identifies further information regarding each of the e-mails. Such information could include the date sent 258, attachments 260, and size 262. For each sender address 256 the user may then indicate one or more of the specific actions 264. The actions may include adding a time limit 265 to the add instruction. If a time is indicated, then the address will be included in the set of allowed addresses for a limited time, and after the time has expired, that address will no longer be an allowed address. If the user wants to add this specific e-mail address to the allow database, then the user would indicate to “add this URL” 267. If the user wants to accept all users from the domain name then the user would indicate by accepting the entire domain 269. Finally, if the user did not want to add this address into the allowed database, then the user could select “don't add” 271.

It will be appreciated that other actions could be indicated in the action area 264. It will also appreciated that the form of the add screen may be changed without affecting the spirit of this invention. The screen illustration 250 also shows a function button 275 for adding the selected addresses, and a function button 277 for opening the edit tools for the allow file. Both the function keys have a count indicator 239 and 238 so that a user could easily see how addresses are going to be added and how many addresses are in the allow file.

It will be appreciated that other actions could be indicated in the action area 154. It will also appreciated that the form of the provisional listing may be changed without affecting the spirit of this invention. The screen illustration 140 also shows a function button 165 for moving to the keyword allowed list and a function button 167 for moving to the bounce list. Both the function keys have a count indicator 168 and 169 so that a user could easily see how many e-mails are in each of the other lists.

Although the particular examples of the electronic messaging system have used e-mails as the electronic message, it will be appreciated that other forms of electronic messages are contemplated. For example, instant messaging provides electronic messages that may benefit from the additional security and privacy offered by the electronic message system.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An electronic message process, comprising:
authorizing a set of allowed addresses;
receiving an electronic message having a sender address and a content portion;
comparing the sender address to the addresses in the set of allowed address;
determining if the sender address is included in the set of allowed addresses; and
displaying the content portion of the electronic message if it is determined that the sender address is included in the set of allowed addresses.

2. The electronic message process according to claim 1 further including:
determining that the sender address is not in the set of allowed addresses; and
deleting the content portion of the electronic message responsive to the determining step.

3. The electronic message process according to claim 1 further including:
determining that the sender address is not in the set of allowed addresses; and
checking if the electronic message includes an authorization code; and if so, then displaying the content portion of the electronic message.

4. The electronic message process according to claim 3 further including adding the sender address into set of allowed addresses.

5. The electronic message process according to claim 1 further including:
determining that the sender address is not in the set of allowed addresses; and
checking if the electronic message includes an authorization code; and if so, then displaying the sender address.

6. The electronic message process according to claim 1 further including:
determining that the sender address is not in the set of allowed addresses;
checking if the electronic message includes an authorization code; and
checking if a previous electronic message from the sender address has included the authorization code, and if so, then not displaying the content portion of the electronic message.

7. The electronic message process according to claim 1 further including:
determining that the sender address is not in the set of allowed addresses; and
checking if the electronic message includes a keyword, and if so, then displaying the content portion of the electronic message.

8. The electronic message process according to claim 1 further including:
determining that the sender address is not in the set of allowed addresses; and
checking if the electronic message includes a keyword, and if so, then displaying the sender address.

9. The electronic message process according to claim 1 further including:
determining that the sender address is not in the set of allowed addresses; and
displaying the sender address responsive to the determining step.

10. The electronic message process according to claim 1 further including:
determining that the sender address is not in the set of allowed addresses; and
sending a responsive electronic message to the sender address indicating that the electronic message is not accepted.

11. The electronic message process according to claim 1 where the electronic message is an e-mail.

12. The electronic message process according to claim 1 further including retrieving the electronic message using a POP service.

13. The electronic message process according to claim 1 where the electronic message is an instant message.

14. The electronic message process according to claim 1, further including associating a time period with an address in the set of allowed address, and if the time period has expired, removing the address from the set of allowed addresses.

15. An e-mail process, comprising:
authorizing a set of allowed URLs;
receiving an electronic message having a sender URL and a content portion; and
determining if the sender URL is found in the set of allowed URLs, and if so, then displaying the content portion of the e-mail.

16. The e-mail process of claim 15, further comprising:
authorizing a set of allowed domains; and
determining if the sender domain is found in the set of allowed domain, and if so, then displaying the content portion of the e-mail.

17. An e-mail process, comprising:
authorizing a set of allowed domains;
receiving an electronic message having a sender domain and a content portion; and
determining if the sender domain is found in the set of allowed domains, and if so, then displaying the content portion of the e-mail.

18. An electronic message process, comprising:
authorizing a set of allowed addresses;
receiving a first electronic message from a first mail account, the first electronic message having a first sender address and a first content portion;
receiving an second electronic message from a second mail account, the second electronic message having a second sender address and a second content portion
determining if the first sender address is included in the set of allowed addresses, and if so, displaying the first content portion of the first electronic message; and
determining if the second sender address is included in the set of allowed addresses, and if so, displaying the second content portion of the second electronic message.

19. The electronic message process according to claim 18, where the first electronic message is retrieved using a POP service, and the second electronic message is retrieved using a POP service.
